(19) United States
(12) Patent Application Publication
(10) Pub. No.: US 2017/0220749 A1
(43) Pub. Date: Aug. 3, 2017

(54) SYSTEMS AND METHODS FOR IDENTIFYING AND USING MEDICAL CALCULATORS

(71) Applicant: MD Aware LLC, New York, NY (US)

(72) Inventors: Joseph Habboushe, New York, NY (US); Graham Walker, San Francisco, CA (US)

(21) Appl. No.: 15/416,831

(22) Filed: Jan. 26, 2017

Related U.S. Application Data
(60) Provisional application No. 62/289,831, filed on Feb. 1, 2016.

(51) Int. Cl. G06F 19/00

(52) U.S. Cl. CPC G06F 19/345

(57) ABSTRACT

Provided are systems and methods that assist medical professionals, healthcare providers, patients and other users to identify medical calculators suitable for diagnosis, prognosis or treatment. Once identified, the systems and methods also facilitate the use of the calculator by the user with appropriate instructions and references, and recommendations to other potentially useful and relevant calculators.

### CROSS REFERENCE TO RELATED APPLICATIONS

This application claims the benefit under 35 U.S.C. 119(e) of U.S. provisional patent application No. 62/289,831, filed Feb. 1, 2016, the disclosure of which is hereby incorporated by reference, in its entirety, for all purposes.

### BACKGROUND

Medical equations are frequently used for clinical diagnosis and treatments. For instance, to determine the dose of a drug based on body surface area (BSA), the BSA can be calculated from the formula of DuBois and DuBois: BSA=(W^{0.425}×H^{0.725})×0.007184.

There are some online tools providing listing of such equations or even calculator programs that take input from a user and carry out the calculation for the user. Given the vast number of calculators available in the literature, each clinician typically has limited knowledge or awareness of many of the calculators, which is a major obstacle for effective use of the calculators.

There is a need, therefore, of tools that help clinicians identify suitable calculators and guide and facilitate their use.

### SUMMARY

The present disclosure provides systems and methods that assist medical professionals, healthcare providers, patients or other individuals (generally referred to as “users”) to identify medical calculators suitable for diagnosis, prognosis or treatment. Once identified, the systems and methods also facilitate the use of the calculator by the user with appropriate instructions and references, and recommendations to other potentially useful and relevant calculators.

In accordance with one embodiment of the disclosure, provided is a method for identifying a medical calculator. In one embodiment, the method comprises receiving, on a computing device, a search string; looking up the search string in a plurality of medical calculators stored in a local non-transitory memory or on a remote server, each of which medical calculators is provided with annotation that comprises, (1) an identification, (2) description of the medical calculator, and (3) one or more tags relating to the purpose, function or classification of the medical calculator, to identify one or more medical calculators having annotation matching the search string; displaying, in a first panel of an electric screen, a listing of the identified one or more medical calculators; allowing a user to select one or more of the tags; and filtering the listing of the identified one or more medical calculators to show only those that associated with the selected tags.

In some aspects, the tags are selected from one or more types of specialty, organ system, disease, chief complaint, or function. In some aspects, the tags are of the type function. In some aspects, the tags are selected from algorithm, calculation, diagnosis, prognosis, rule out and treatment.

In some aspects, the method further comprises looking up the search string in a plurality of filters stored in a local non-transitory memory or on a remote server, each of the filters is associated with one or more keywords relating to one or more of the medical calculators, to identify one or more filters having associated keywords matching the search string; displaying, in a second panel of the electric screen, a listing of the identified one or more filters; allowing a user to select one or more of the identified filters; and displaying a listing of one or more of the medical calculators associated with the selected disease or complaint.

In some aspects, the filters are determined from the listing of the identified one or more medical calculators to represent clusters of medical calculators in the listing.

In some aspects, the plurality of medical calculators are stored in a local non-transitory memory. In some aspects, the method further comprises determining whether the stored medical calculators need updating. In some aspects, the determination comprises comparing the stored medical calculators to medical calculators provided on a remote server.

In some aspects, the method further comprises, in response to a user selection of a medical calculator, displaying on a third panel on the electric screen one or more variables of the medical calculator, which allows the user to provide input to each of the variables.

In some aspects, at least one of the variables is provided with a default value that is predetermined. In some aspects, the method further comprises determining whether an input provided by the user is acceptable or within a normal range. In some aspects, the method further comprises displaying an alert when the input is not acceptable.

In some aspects, the method further comprises displaying an alert that the input is not within the normal range and displaying a calculated result based on the input.

In some aspects, the method further comprises displaying details of the result when the user clicks on the result, wherein the details comprise acceptable ranges, normal ranges, and/or intermediate results.

In some aspects, the annotation of the medical calculators further comprises one or more of: name; one or more required input; listing of technical references; advice on next step; information of creator of the medical calculator; indications of use; pearls or pitfalls; or explanation of evidence and/or synopsis of the studies.

### BRIEF DESCRIPTION OF THE DRAWINGS

FIG. 1 illustrates an interface with a partial listing of available medical calculators.

FIG. 2 shows that a keyword is entered to search for medical calculators.

FIG. 3 shows that the search results are filtered with a filter “Chest pain.”

FIG. 4 shows pre-determined tags and filters useful for narrowing down search results.

FIG. 5 shows some example filters in the disease category.

FIG. 6 shows that a “Diagnosis” tag is applied that further narrows down the search results.

FIG. 7 shows that, instead of “Diagnosis,” a “Rule Out” tag is applied.

FIG. 8A presents an interface of a medical calculator “HEART Score.”

FIG. 8B illustrates that when an input is given that is out of an acceptable range, a blocking alert is given by the system and no calculation is performed.

FIG. 8C illustrates that when an input may be out of an acceptable range, but is still a possible input, a warning alert is given by the calculation is performed and result shown.

FIG. 9 shows that the calculator “HEART Score” is presented with recommendation for “Next Steps.”

FIG. 10 shows instructions for using the calculator “HEART Score.”

FIG. 11 presents an “About” page of the “HEART Score” calculator.

FIG. 12 shows an example of a computer system on which techniques described in this paper can be implemented.

It will be recognized that some or all of the figures are schematic representations for example and, hence, that they do not necessarily depict the actual relative sizes or locations of the elements shown.

### DETAILED DESCRIPTION

Medical calculators are useful for physicians and other medical professionals but many medical professionals, even if familiar with a small number of calculators that they use routinely, are generally not aware of others, in particular newly developed ones. Further, even when a medical professional has heard of a medical calculator, the medical professional may be hesitant in using it due to the lack of familiarity and time required to gather relevant information for using the calculator. Other healthcare providers (e.g., off-site nurses), patients, and any individual needing healthcare information or service also desire to use medical calculators.

Identification of Medical Calculator

The present disclosure provides systems and methods for assisting medical professionals and other users to identify a suitable medical calculator for a particular application that the user needs. Once the medical calculator is identified, the systems and methods also provide detailed instructions, friendly interface, scientific references, and other related calculators to further improve the use and productivity of the medical calculator.

Certain embodiments of the present technology are illustrated in the attached figures and are explained in detail below.

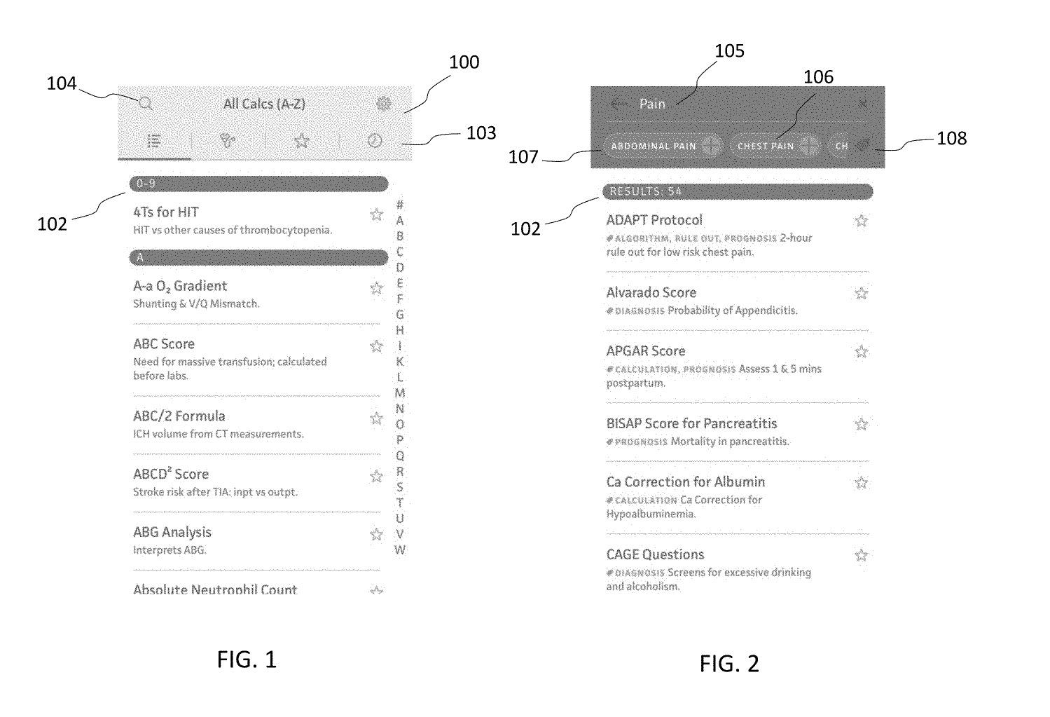

FIG. 1 shows a graphic interface presented on an electronic screen (100), which includes a main menu (103) and a partial listing of available medical calculators in panel 102. In addition, at the top left corner of the interface, a search icon allows a user to enter a search interface, illustrated in FIG. 2.

Once a user clicks on the search icon 104, the user is shown a search interface which includes a top search box (105), a filter/tag region (107), and a main panel (102) for displaying the search results. In the example of FIG. 2, the user types in “Pain” as a search query, because a patient complains about pain in the body. With the search query, the system conducts one or more searches in one or more databases.

The term “database” refers generically to any collection of information that is structured, either as a traditional relation table or otherwise, to enable searches and updates. A database can be located locally on a computer device on which the processor receives a search query and conducts a search, or remotely through a computer network. In one embodiment of the present technology, the computing device that includes the electronic screen that displays the graphic interface store a local copy (or partial copy) of the database(s) in which the searches are conducted. The local copy enables use of the system when no internet is accessible, for instance, at an underground emergency room.

The local copy can be updated on demand or when a predetermined set of criteria are met (e.g., update frequency or schedule). In some embodiments, the program code in the system for carrying out the search and calculation can also be updated when a new version is available or when the program code changes. In one embodiment, updates to the program code and to the local copy of the database are independent of each other. That is, the system checks whether the content of the database needs updating (e.g., by comparing version number, content size, or the content itself) independently from checking whether the program code (e.g., the software package or smart phone app) needs updating. In some embodiments, each medical calculator can be independently checked and updated. For instance, each medical calculator is associated with a version tag (e.g., MD5/ETag) which changes when the calculator is updated. Thus, when the version tag for medical calculator is different between the local copy and the server, an update is appropriate and can be triggered.

One of the searches entails looking up the search query (e.g., “Pain”) against each medical calculator in the database. To this end, each medical calculator entry in the database is associated with suitable annotations and categorizations, as further explained below.

As used herein, a “medical calculator” refers to a computational tool (or corresponding formula, equation or clinical decision rule) that produces a result useful in a medical setting, such as diagnosis, prognosis, health care evaluation, and treatment optimization, without limitation. The tool can take inputs of different types, such as numerical inputs, discrete inputs, categorical input (e.g., yes/no) or does not require an input (e.g., indication of staging of cancers).

A medical calculator can be annotated with definitions or description for each of its inputs, the output, the purpose, the interpretation of the likely output, references relating to the calculator, and author of the calculator. Each medical calculator can also be associated with a plurality of keywords (e.g., symptoms, complaints) that are likely used for searching for the calculator. Moreover, the keyword list can further include synonym, acronyms and abbreviations. Each of these types of information can be used for matching the calculator with a search query.

A medical calculator can be associated with one or more “tags” useful for the search. Tags are generated on different types of categorizations, such as the following:
1. Specialty (e.g. cardiology, emergency medicine)
2. Organ system (e.g. cardiovascular; renal, pulmonary)
3. Disease (e.g. heart attack, pulmonary embolism, pneumonia)
4. Chief complaint (e.g. chest pain, shortness of breath, headache)
5. Function (e.g. rule-out, diagnose, prognosticate, treat)

In one embodiment, at least a medical calculator is annotated with at least one of the above categories of tags, i.e., one of specialty, organ system, disease, chief complaint, or function. In one embodiment, at least a medical calculator is annotated at least with two of the above categories of tags. In some aspects, the two categories include at least function. In some aspects, the two categories include at least disease or chief complaint. In some aspects, at least a medical calculator is annotated at least with three of the above categories of tags. In some aspects, the three categories include at least a function. In some aspects, the three categories include at least disease or chief complaint. In some aspects, the three categories include at least disease, chief complaint and function.

Conversely, each tag is associated with one or more medical calculators. Moreover, each tag can be further annotated with keywords or synonym, acronyms and abbreviations of the keywords. One way of generating such a keyword list is to incorporate the keywords from each medical calculator associated with the tag.

To further facilitate search, the system can be configured to further display one or more suggested filters based on the search query, which can include the tags as well as other information. In one embodiment, when a search query is entered, the system searches through all tags and identify those that are associated with the search query (e.g., as associated keywords). The identified tags are then provided to the user to be used to narrow down the search results.

The filters do not have to be tags, however. In one embodiment, a filter is any category of one or more medical calculators. In another embodiment, the filter is a word, phrase or abbreviation that relates to a search query. The relationship can be pre-determined, such as a tag that is associated with a list of keywords. In this example, when one of the keywords is used as the search query, the tag is identified as a filter for potential use.

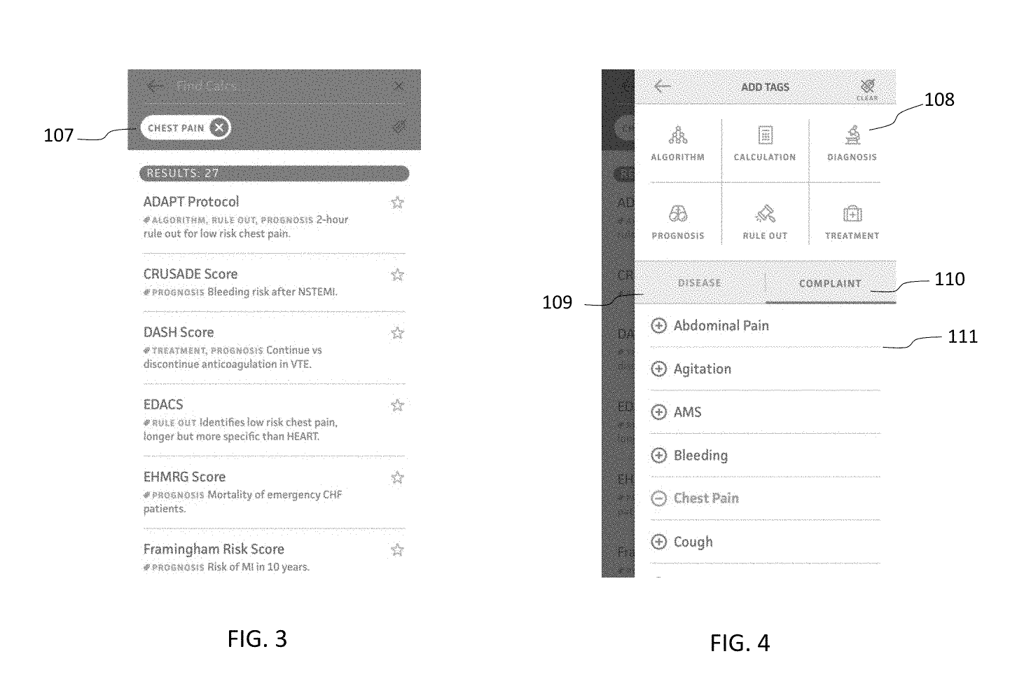

As illustrated in FIG. 2, when the search term “Pain” is entered, the system also searches through all filters and has identified, for instance, “Abdominal Pain” and “Chest Pain” as potential filters (106). To use the filter, the user can simply click on the filter, which will then be left at the filter list (the other, unused filters are then cleared), as shown in FIG. 3. Here, when the filter “Chest Pain” is applied, the search results are accordingly narrowed down.

In some embodiments, a filter can be identified dynamically on the fly. For instance, when the search query is searched through the database, related medical calculators, tags and/or pre-determined filters can be identified. Data mining can then be applied on these initial search results to identify major themes (e.g., clusters) among the search results. For instance, words and categories that appear most frequently can be automatically collected to be presented to the user as potential filters. For example, when the search query “Pain” is used, the words “chest”, “headache”, “NSAID”, “bleeding”, and “diagnosis” may be found to be the most frequently associated with the search results and thus are selected as filters.

As apparent from FIGS. 2 and 3, each search result (i.e., a medical calculator) shows up with a name, a brief description, and optionally one or more tags. The appearance of the tags here helps a user get familiarized with the search system, and also provides a quick way to use the tags to filter results. For instance, on FIG. 3, the user sees that the calculator “Framingham Risk Score,” as well as a few others, are tagged as a “Prognosis” calculator. By clicking on the tag “Prognosis”, all the search results are filtered with this tag (i.e., only calculators having the tag “Prognosis” will remain in the search results).

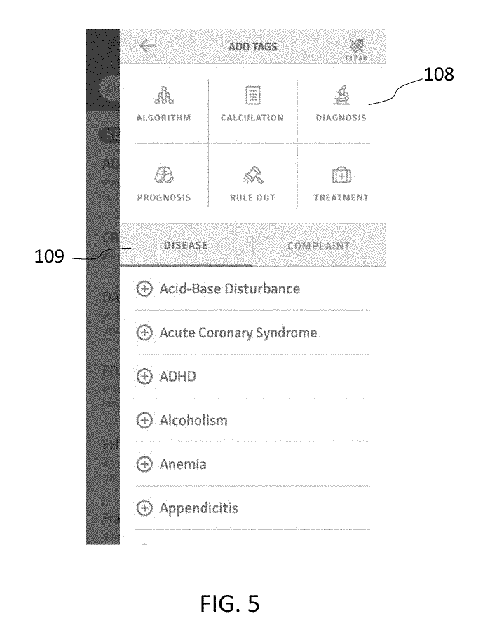

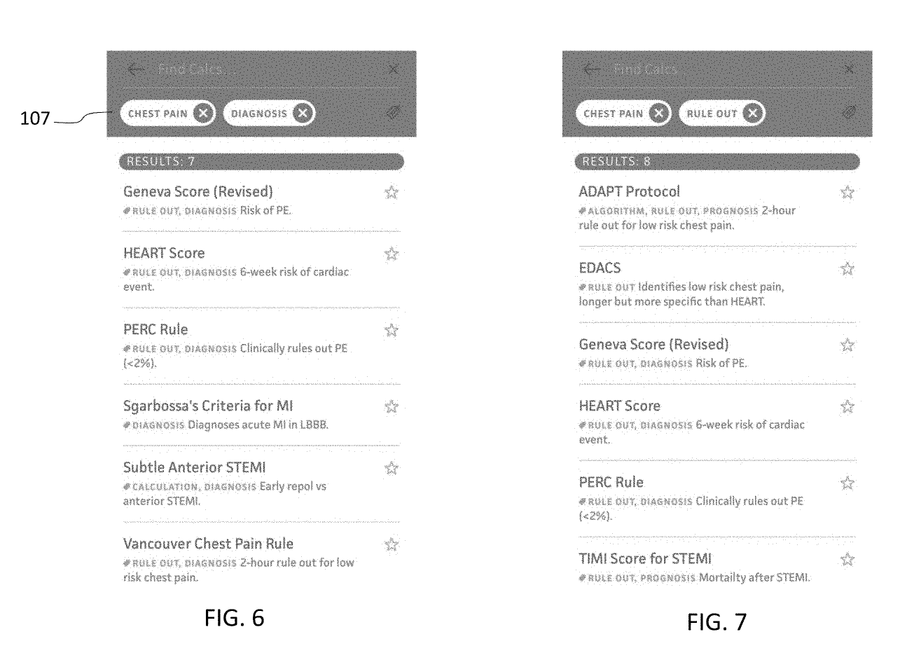

Another way of selecting and using tags is through the tag interface as illustrated in FIGS. 4 and 5. In FIG. 4, the interface includes a function tag panel (108), a disease tag panel (109, only title shown; examples of disease tags are shown in FIG. 5), and a complaint panel (110) with a listing of available complaint tags (111). Here, because the filter/tag “Chest Pain” is already selected, it is greyed out. On this interface, the user can click and select, e.g., “Diagnosis”. Accordingly, as FIG. 6 shows, only medical calculators with the “Diagnosis” tag is shown in the result panel. It is readily appreciated that more than one tag or filter can be used for each search. For instance, then the tag “Rule Out” is selected on top of “Chest Pain”, the results are different (FIG. 7).

In another example (not shown in figures), a doctor may want to know the chance a patient has of having a pulmonary embolism (PE) in order to determine the best way to work them up, so the doctor can search “Pulmonary Embolism” (a disease) and “Diagnose” (a function). In a related example, the patient will be diagnosed with a PE, and then the treating physician will choose “Pulmonary Embolism” and “Prognosticate” to find calculators that help determine chance of mortality (for example, to help guide inpatient vs. outpatient treatment), and/or “Pulmonary Embolism” and “Treatment” to help choose which medicine and/or procedure are useful.

Guided Use of Medical Calculator

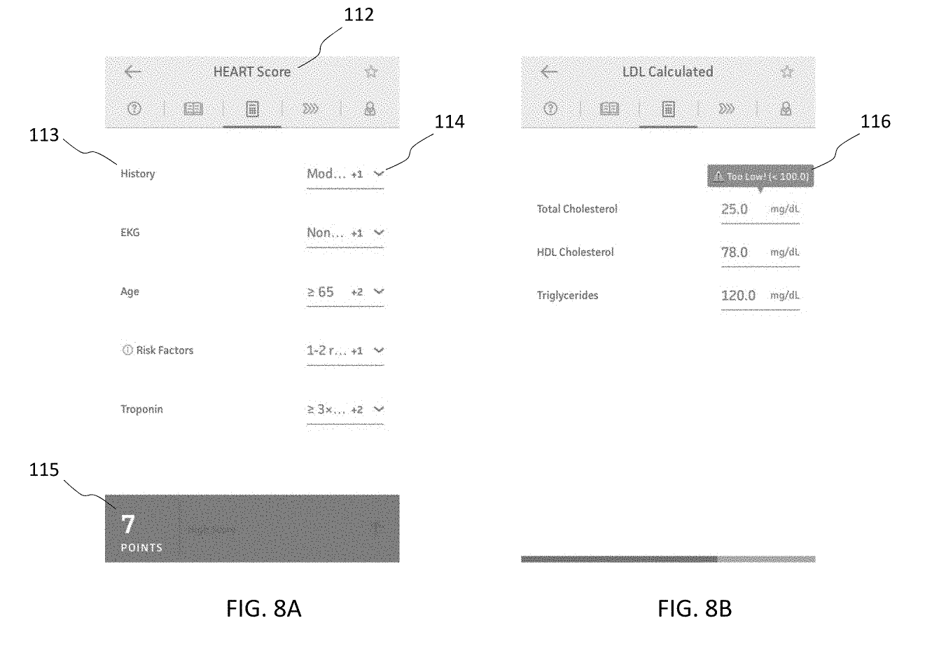

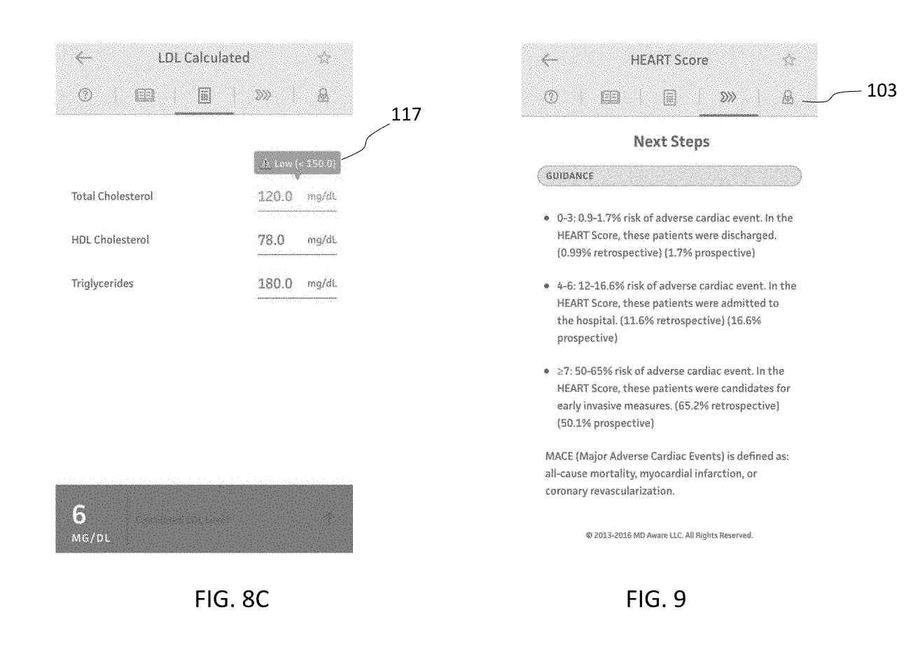

Once a medical calculator is selected, the system presents a user interface for using the calculator, as illustrated in FIG. 8A-8C. In FIG. 8A, a medical calculator named “HEART Score” is shown at the top (112), which takes a number of inputs (114) for parameters including History, EKG, Age, Risk Factors, and Troponin (113). The format of the input depends on the type of data. Once all requisite inputs are provided by the user, a result is shown at the bottom panel (115).

In some scenarios, when a user enters an input that is beyond the acceptable or normal range, the system provides a mechanism for detecting such abnormality and providing an alert or even requires the user to change the input. For instance, as illustrated in FIG. 8B, the system includes an acceptable range for a total cholesterol level of 100-500 mg/dL (which is optionally displayed when the user provides the input), and a normal range of 150-200 mg/dL (which is optionally displayed when the user provides the input). When the user enters 25, the system displays an alert (116) indicating that the input is “Too Low! (<100.0)” (FIG. 8B).

Similarly, when the user enters 120, the system displays an alert (117) indicating that the input may be outside an acceptable range, but is still a possible input (FIG. 8C). Nevertheless, a calculation is performed and the result is displayed at the bottom.

In some embodiments, when a user clicks on the result shown on the display (e.g., at the bottom of the screen), the systems brings up an interface showing more details of the results. Such further details include, for example, indication whether the result is normal or abnormal, the reference range, buttons or links to interpretation of the result, and/or intermediate results of the calculation.

In some embodiments, when a user attempts to enter an input, at the input interface, the system display one or more of the following: default value, normal range of values, and acceptable range of values. In some embodiments, rather than providing a blank space for the user to enter a value, the system includes a default value and allows the user to change or update.

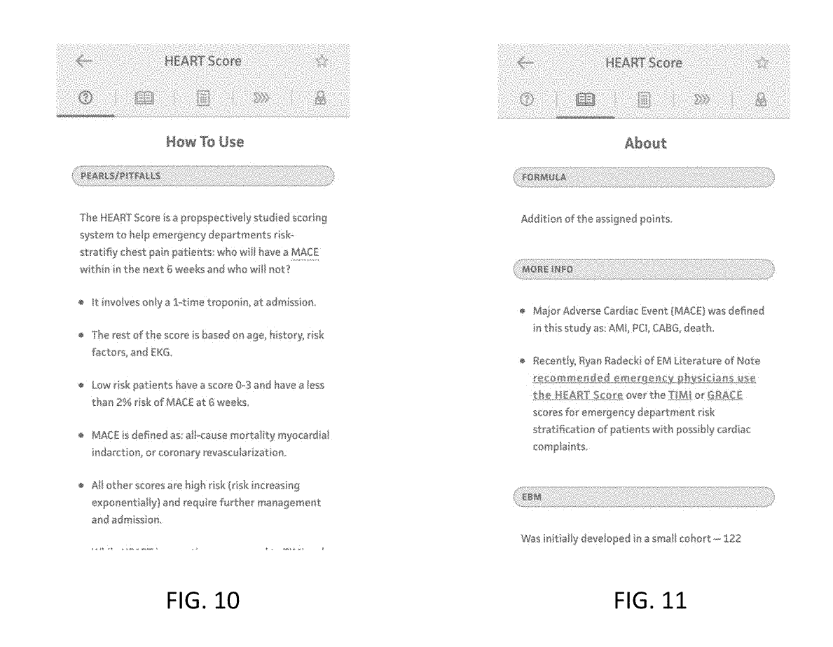

In some embodiments, to further assist the user, information relevant to the use, interpretation, and/or scientific resource can also be provided. For instance, by clicking on different tabs on the top, the user can view the “How to Use” (FIG. 10), “Next Steps” (FIG. 9), and “About” (FIG. 11) pages.

The program code that enables the system to perform various search, display, calculation and other functions can be programmed in a manner that enables the deployment of the program in any computing system, including without limitation computer servers (e.g., on a web interface), personal computers, tablets, smart phones and smart watches.

Connection to Professional Support

When a user searches for or uses a medical calculator, the system can recognize the medical service that user may potentially need. In this respect, the system can include information of medical service providers (e.g., doctors, hospital, healthcare consultants) and provide the information to relevant users and at an appropriate interface.

Information of medical service providers can be added to the system by administrators managing the system, but preferably added by the providers themselves. In one instance, each medical service provider is able to create an account on the system and add its contact, medical expertise, and location, without limitation. The creation of the account and addition of the information can be either controlled by a system administer, or automatically authorized given certain credential (e.g., email address) pre-approved by the system. For example, a user with an email address ending with @nyumc.org will be able to register as a medical professional or organization and add information related to New York University Medical Center.

In addition to adding the information of the medical service provider into the system, the provider can further associate such information to one or more medical calculators, tags, or filters. Therefore, when a user searches for calculators relating to “Chest Pain”, in addition to displaying a list of medical calculators, the system also includes listing of medical service providers that have associated the services they provide to diseases causing chest pain.

In another example, during a search, when a user navigates to the interface displaying relevant tags or filters, the user will be able to see a list of medical service providers by clicking at a tag or filter. For instance, when the user clicks on “radiology”, a list of radiologists (or medical service providers associating themselves to the filter “radiology”) will be displayed along with the medical calculators.

The search and display can further be personalized based on a user's location or other characteristics. For instance, different medical service providers may be identified and listed depending on the age or gender of the user. In this respect, the user can opt to provide location, age or gender to the system, and the medical service providers need to annotate their service to certain location, age, and/or gender groups.

Computing Systems for Implementing the Technology

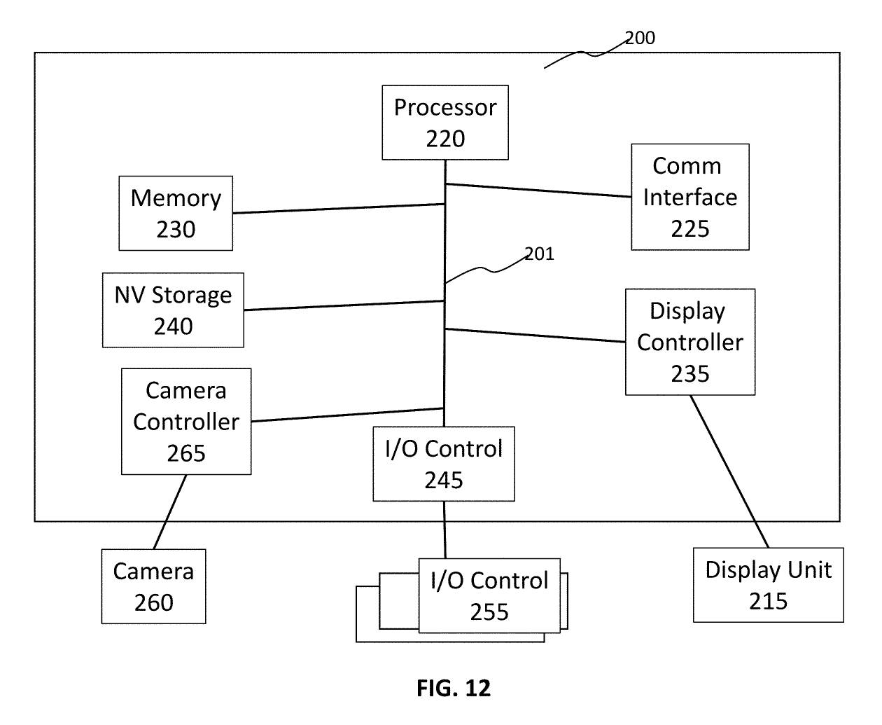

FIG. 12 shows an example of a computer system 200 on which techniques described in this paper can be implemented. The computer system 200 can be a conventional computer system that can be used as a client computer system, such as a wireless client or a workstation, or a server computer system. The computer system 200 includes a computer 205, I/O devices 255, and a display device 215. The computer 205 includes a processor 220, a communications interface 225, memory 230, display controller 235, camera controller 265, non-volatile (NV) storage 240, and I/O controller 245. The computer 205 may be coupled to or include the I/O devices 255, camera 260, and display unit 215.

The computer 205 interfaces to external systems through the communications interface 225, which may include a modem or network interface. It will be appreciated that the communications interface 225 can be considered to be part of the computer system 200 or a part of the computer 205. The communications interface 225 can be an analog modem, ISDN modem, cable modem, token ring interface, satellite transmission interface (e.g. “direct PC”), or other interfaces for coupling a computer system to other computer systems.

The processor 220 may be, for example, a conventional microprocessor such as an Intel Pentium microprocessor or Motorola power PC microprocessor. The memory 230 is coupled to the processor 220 by a bus 250. The memory 230 can be Dynamic Random Access Memory (DRAM) and can also include Static RAM (SRAM). The bus 250 couples the processor 220 to the memory 230, also to the non-volatile storage 240, to the display controller 235, and to the I/O controller 245.

The I/O devices 255 can include a keyboard, disk drives, printers, a scanner, and other input and output devices, including a mouse or other pointing device. The display controller 235 may control in the conventional manner a display on the display device 215, which can be, for example, a cathode ray tube (CRT) or liquid crystal display (LCD). The display controller 235 and the I/O controller 245 can be implemented with conventional well-known technology.

The non-volatile storage 240 is often a magnetic hard disk, an optical disk, or another form of storage for large amounts of data. Some of this data is often written, by a direct memory access process, into memory 230 during execution of software in the computer 205. One of skill in the art will immediately recognize that the terms “machine-readable medium” or “computer-readable medium” includes any type of storage device that is accessible by the processor 220 and also encompasses a carrier wave that encodes a data signal.

The computer system 200 is one example of many possible computer systems that have different architectures. For example, personal computers based on an Intel microprocessor often have multiple buses, one of which can be an I/O bus for the peripherals and one that directly connects the processor 220 and the memory 230 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 230 for execution by the processor 220. A Web TV system, which is known in the art, is also considered to be a computer system, but it may lack some of the features shown in FIG. 12, such as certain input or output devices. A typical computer system will usually include at least a processor, memory, and a bus coupling the memory to the processor.

In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller. An example of a computer system is shown in FIG. 12.

The memory can include, by way of example but not limitation, random access memory (RAM), such as dynamic RAM (DRAM) and static RAM (SRAM). The memory can be local, remote, or distributed. As used in this paper, the term “computer-readable storage medium” is intended to include only physical media, such as memory. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used in this paper, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

Several components described in this paper, including clients, servers, and engines, can be compatible with or implemented using a cloud-based computing system. As used in this paper, a cloud-based computing system is a system that provides computing resources, software, and/or information to client devices by maintaining centralized services and resources that the client devices can access over a communication interface, such as a network. The cloud-based computing system can involve a subscription for services or use a utility pricing model. Users can access the protocols of the cloud-based computing system through a web browser or other container application located on their client device.

This paper describes techniques that those of skill in the art can implement in numerous ways. For instance, those of skill in the art can implement the techniques described in this paper using a process, an apparatus, a system, a composition of matter, a computer program product embodied on a computer-readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used in this paper, the term ‘processor’ refers to one or more devices, circuits, and/or processing cores configured to process data, such as computer program instructions.

A detailed description of one or more implementations of the invention is provided in this paper along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus can be specially constructed for the required purposes, or it can comprise a general-purpose computer selectively activated or reconfigured by a computer program stored in the computer. Such a computer program may be stored in a computer-readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

As disclosed in this paper, implementations allow editors to create professional productions using themes and based on a wide variety of amateur and professional content gathered from numerous sources. Although the foregoing implementations have been described in some detail for purposes of clarity of understanding, implementations are not necessarily limited to the details provided.

1. A method for identifying a medical calculator, comprising:
receiving, on a computing device, a search string;
looking up the search string in a plurality of medical calculators stored in a local non-transitory memory or on a remote server, each of which medical calculators is provided with annotation that comprises, (1) an identification, (2) description of the medical calculator, and (3) one or more tags relating to the purpose, function or classification of the medical calculator, to identify one or more medical calculators having annotation matching the search string;
displaying, in a first panel of an electric screen, a listing of the identified one or more medical calculators;
allowing a user to select one or more of the tags; and
filtering the listing of the identified one or more medical calculators to show only those that associated with the selected tags.

2. The method of claim 1, wherein the tags are selected from one or more types of specialty, organ system, disease, chief complaint, or function.

3. The method of claim 2, wherein the tags are of the type function.

4. The method of claim 3, wherein the tags are selected from algorithm, calculation, diagnosis, prognosis, rule out and treatment.

5. The method of claim 1, further comprising:
looking up the search string in a plurality of filters stored in a local non-transitory memory or on a remote server, each of the filters is associated with one or more keywords relating to one or more of the medical calculators, to identify one or more filters having associated keywords matching the search string;
displaying, in a second panel of the electric screen, a listing of the identified one or more filters;
allowing a user to select one or more of the identified filters; and
displaying a listing of one or more of the medical calculators associated with the selected disease or complaint.

6. The method of claim 5, wherein the filters are determined from the listing of the identified one or more medical calculators to represent clusters of medical calculators in the listing.

7. The method of claim 1, wherein the plurality of medical calculators are stored in a local non-transitory memory.

8. The method of claim 7, further comprising determining whether the stored medical calculators need updating.

9. The method of claim 7, wherein the determination comprises comparing the stored medical calculators to medical calculators provided on a remote server.

10. The method claim 1, further comprising, in response to a user selection of a medical calculator, displaying on a third panel on the electric screen one or more variables of the medical calculator, which allows the user to provide input to each of the variables.

11. The method of claim 10, whether at least one of the variables is provided with a default value that is predetermined.

12. The method of claim 10, further comprising determining whether an input provided by the user is acceptable or within a normal range.

13. The method of claim 12, further comprising displaying an alert when the input is not acceptable.

14. The method of claim 12, further comprising displaying an alert that the input is not within the normal range and displaying a calculated result based on the input.

15. The method of claim 10, further comprising displaying details of the result when the user clicks on the result, wherein the details comprise acceptable ranges, normal ranges, and/or intermediate results.

16. The method of claim 1, wherein the annotation of the medical calculators further comprises one or more of:
name;
one or more required input;
listing of technical references;
advice on next step;
information of creator of the medical calculator;
indications of use;
pearls or pitfalls; or
explanation of evidence and/or synopsis of the studies.
